(19) United States
(12) Patent Application Publication
(10) Pub. No.: US 2009/0241439 A1
(43) Pub. Date: Oct. 1, 2009

(54) Method and Device for Producing Precast Components and Corresponding Precast Component

(76) Inventor: Juergen Rothermel, Rimbach (DE)

Correspondence Address: KOHLER SCHMID MOEBUS, RUPPMANNSTRASSE 27, D-70565 STUTTGART, DE

(21) Appl. No.: 11/920,727

(22) PCT Filed: May 22, 2006
(86) PCT No.: PCT/EP2006/004838

§ 371 Date: Nov. 20, 2007

(30) Foreign Application Priority Data
May 25, 2005 (DE) 10 2005 024 569.2
Aug. 18, 2005 (DE) 10 2005 039 522.8
Nov. 12, 2005 (DE) 10 2005 054 087.2

(51) Int. Cl. E04G 21/14; E04G 13/00; B29C 39/10

(52) U.S. Cl. 52/125.4; 249/15; 264/108

(57) ABSTRACT

The invention relates to a method and a device for producing precast components (1) that comprise a base (1′) and a wall element (1″) using a concrete casting mold (2) having the shape of the precast component (1). The aim of the invention is to produce precast components in a single processing step and to allow for a firm connection between the concrete (4) and a natural stone (5). For this purpose, the concrete casting mold (2) is filled with concrete (4) with the visible side (3) of the wall element (1″) of the precast component (1) to be produced facing upward. At least one natural stone (5) is brought into a defined position in the unset concrete (4) at a depth of immersion sufficient for a reliable connection with the concrete (4) using at least one retaining element (9) and is maintained in this position until the concrete (4) has attained strength sufficient to hold the position of the at least one natural stone (5). The precast component (1) is removed from the concrete casting mold (2) when the concrete has attained sufficient strength.

The invention relates to a method and a device for producing precast components that comprise a base element and a wall element using a concrete casting mold with the shape of the precast component. The invention also concerns precast components as well.

When such concrete precast components are to be decorated with natural stones on the visible side, the usual procedure, as known from DE 74 19 996 U1, is to produce a cast element comprising a base element and a wall element and then to apply natural stones to the visible surface of the wall element.

This procedure is quite work-intensive as it involves several processing steps and it is only suitable for relatively thin natural stone material. The subsequent attachment of natural stones to the precast component does not provide lasting, high stability. Furthermore, rustic natural stones, such as boulders or quarry stones, cannot be processed in this way owing to their irregular dimensions and to their—often considerable—thickness.

Furthermore, the DE 43 01 118 C2 publication explains how casting a reinforced ground slab and then covering the surface with natural stones can produce planar precast components. The open joints are then filled with a concrete mix. However, only planar precast components can be produced in this manner.

This method of precast component production also requires several processing steps. After having cast the base slab, you have to wait a while until the base slab is able to hold the load before the stones can be attached and the spaces in between can be filled. The latter work step is quite work-intensive and a firm connection between base slab and natural stone cannot be guaranteed. Weak connections, gaps and cavities which may occur between the natural stones and the base slab and in the joints may cause water to soak in, which in turn may cause the natural stones to loosen from the base slab when exposed to frost. Furthermore, this method requires use of natural stones that are evenly trimmed, have a planar supporting surface, which are of the same thickness and which create comparatively even joints between each other. Rustic natural stones such as boulders or quarry stones with uneven boundaries and different dimensions, and especially large stones or even rocks, are not suitable for this production method.

Quite frequently, as, for instance, proposed by DE 198 01 378 A1 or DE 20 2004 019 390 U1, precast components to be used as walls or as base slabs are produced by arranging the natural stones on the ground and by covering them with concrete. When using this procedure, the concrete must, of course, be prevented from flowing to the visible side of the stones, for instance by jointing the stones in advance. Apart from the efforts needed for the latter, only flat stones, paving stones or, as suggested by DE 18 32 191 U1, crushed stones can be used in this manner. U.S. Pat. No. 1,809,504 also describes a method, which enables the processing of even unhewn natural stones. For this purpose, the natural stones are arranged on a sand bed that also prevents the concrete from flowing to the front side of the stones. In order to keep the efforts for the required sand bed and for the embedment of the stones within justifiable limits, this method also calls for stones of similar dimensions. Since the side wall that will later be visible cannot be seen during the production process, the result cannot be monitored and, if necessary, be corrected during the production process. The embedding in the sand has to be checked manually and often be prepared by hand, in particular, if stones of different sizes and very big stones are used and if pits for placing the stones have to be provided in the sand.

DE 16 59 106 A1 describes a method and a device for the production of plate-like precast components by pouring a flowable concrete mix into a mold and by then pressing the stones into the concrete, applying more or less force. The stones are then surrounded with grooves, which are filled with concrete or mortar, so as to improve the seating of the stones in the framing through higher concrete density. This procedure has the disadvantage that the concrete must be viscous to hold the load of the stones, and, at the same time, it must be sufficiently fluid so that the stones can be pressed into the concrete. This problem already occurs with stones of different sizes, as the bearing capacity required for a stone of, for example, only 1 kg is far less than the bearing capacity for a considerably larger stone weighing, for example, 1 ton. For such a large stone it is rather difficult—if not impossible—to define the concrete (mixture and point in time) in such a way, so that it is suitable to connect with the stone while, simultaneously, preventing it from sinking in.

Furthermore, it is difficult to precisely define the mixture and time so that all stones of any dimensions will stay in their desired position and will not sink-in or be displaced. If, in order to avoid the latter, a concrete mix of a highly viscous consistency is chosen, the stones which are placed deeper must be pressed in to their desired position with high pressure, which requires substantial effort. Using a concrete mix that can already hold the load of the stones when they are applied will result in an insufficient connection between the stone and concrete, meaning that the above-mentioned framing with high-density concrete or mortar will be required to provide additional support for the stones. This requires a further processing step, which has to be carried out manually if the stones are irregular in shape.

DE 23 33615 A describes a method for the application of an external layer of stones or particles to the outside of cast bodies, especially concrete slabs, in order to provide them with a facing. For this purpose, a flexible supporting element, for instance made of plastic, is used as an auxiliary material. The stones or particles are pressed into the surface of the supporting element or they are fixed to the surface with the help of a binding material. These flexible supporting elements are then pressed onto a casting, for instance concrete. After the casting, e.g. after the concrete material has hardened, the supporting element can be removed, whereby the stones or particles are removed from the supporting element and remain on the concrete slab as the facing layer. This is, however, not a solution for a precast component with a base element and a wall element.

Above all, this method is only suitable for the production of facings consisting of particles or small stones. Larger stones cannot be used as they cannot be pressed into the surface of the flexible supporting element and be held by the binding material, particularly as the bond must be suitable to remove the stones or particles from the flexible supporting element again, so that they remain in the concrete without showing leftovers from the supporting element. This method only allows processing of comparatively small stones about the size of grit or gravel with a weight of considerable less then 1 kg. Larger stones cannot be carried by the flexible supporting element, neither by pressing the stones into its surface, nor by using a binding material. Furthermore, this method only allows the stones to be positioned on flat surfaces but not in a three dimensional arrangement. The latter, however, is desirable with larger stones, since, in contrast to grit or gravel, the single stones will be visually perceived and require a greater freedom of design, so that, for example, one specific side of a stone can be selected to form a projection and to position it on the wall accordingly.

Hence, the purpose of the invention is to provide for the production of precast components as described above to be carried out in one single processing step while, at the same time, a firm connection between the concrete and the natural stone is guaranteed and, furthermore, natural stones, especially rather big and unhewn stones, can be positioned in the concrete in virtually any position. Further tasks include a short drying-cycle time for the precast component in the mold as well as ensuring that the precast components and the method used to produce said components do not allow or barely allow for the components to be seen as single elements.

According to the invention and with regard to the method to be used, the task is solved by filling the concrete casting mold with concrete, whereby the visible side of the wall element of the precast component to be produced faces upwards, and by using at least one natural stone which is brought into a defined position in the unset concrete by immersing it into the concrete with the help of at least one retaining element until it reaches a depth that ensures a reliable connection with the concrete, and by maintaining the natural stone in this position until the concrete has become hard enough to hold at least one natural stone in this position, whereby spacers are used as retaining elements which are suitable to carry at least one natural stone and which are inserted into the concrete casting mold and covered by the concrete, and by removing the precast component from the concrete casting mold when the concrete has sufficiently hardened.

One further solution according to the invention and with regard to the method is to fill the concrete casting mold with concrete, whereby the visible side of the wall element of the precast component to be produced shows upwards. At least one natural stone is brought into a defined position in the unset concrete with the help of at least one retaining element until it is immersed deeply enough so as to ensure a reliable connection with the concrete and is kept in this position until the concrete has become hard enough to hold the at least one natural stone in its position, whereby at least one suspension is used as the retaining element and is attached to a spot on the surface of the stone which is not immersed in the concrete, and the precast component is removed from the concrete casting mold when the concrete has become sufficiently hard.

According to the invention and with regard to the device, the task is solved by providing the device with retaining elements designed as spacers which can be inserted into the concrete casting mold in order to carry the at least one natural stone and to keep the stone in a defined position and in a defined area of immersion within the concrete casting mold when the concrete is cast until the concrete has become hard enough to hold the natural stone in its position.

With the invention, it is possible to keep the concrete sufficiently flowable while immersing the natural stone, so that it covers the immersed stone surface thinly, as well as to provide a firm connection between the stone and the concrete after hardening. With a suitably composed concrete mix, the stones need to be held in the concrete only temporarily, as the green hardness and consequently the bearing capacity of the concrete required for the stones will be achieved relatively soon. The time span the concrete needs to set can be matched with the time required to arrange the stones by adjusting the concrete mix ratio accordingly.

The invention is suitable for the processing of crude and unhewn stones, for instance from a quarry or boulders. Planar surfaces for supporting purposes are not required. If for instance, the device should be used to bring several larger stones into position, any gaps between the stones can, of course, be filled manually by putting smaller stones into the concrete. An essential advantage of the invention is, however, that natural stones, especially very large ones, can be brought into virtually any position as desired. The only important aspect is to immerse the natural stone deeply enough so as to ensure a solid connection when the concrete has set.

The invention is especially suited for the production of very solid walls such as retaining walls and noise protection walls used in road construction, in water engineering, in the establishment of railway lines, in vineyard construction or in build-up areas located in slopes. The basic idea of the invention is the use of big natural stones—with a minimum grain size of 200 mm—up to very large stones weighing several tons for the visible side of the precast components mentioned above. One essential aspect is that the stones can be supported or moved in any direction and in any depth of immersion until the concrete has set. Stones of very different sizes can be used in order to keep the gaps between irregularly formed natural stones as small as possible so the concrete will be hardly visible. It is possible to create comparatively flat wall surfaces even if stones of very different sizes are used, as the stones can be placed in any desired position, for example with pleasing or planar outside surfaces, and it is also possible to insert even large stones (of one or more tons in weight) into the concrete so that their face sides have almost the same level as those of smaller stones—weighing, for example, only a few kilograms. Since it is possible to choose which side of the stones shall be visible, not only planar surfaces but a great variety of further surface designs can be realized. The same procedure can be used to integrate protruding natural stones or to form recesses so as to create a wall that comes close to the optical appearance of a natural rock face and to achieve an aesthetic impression in the surrounding landscape. For this reason it is obvious that the opportunities offered by the invention far exceed the presently known application of coatings or facings on walls. In fact, natural stone walls can be generated, if desired with ledges and cantilevers for planting, which fit into the landscape and cannot easily be identified as a man-made object, and which may even enrich the landscape.

With this invention it is possible to produce a precast component in one processing step in series machine production. In order to be independent from weather conditions or seasons, production can be carried out in halls. Through a comparatively deep immersion of the stones into the still flowable concrete, a firm connection between the natural stones and the concrete without noteworthy cracks or cavities can be obtained, which can, in particular, withstand strain conditions without any problems for decades, especially alternating exposure to humidity and frost.

Since rocks and not only stone slabs can be processed, the stability and the weather resistance are substantially increased. The rocks are solid and firmly connected to the wall which prevents the stones from crumbling or from dropping out of the wall, which facings of planar natural stones tend to do. Furthermore a blooming of the concrete, caused by lime passing through natural stones is nearly impossible if, as proposed, large stones are used. This allows for a pleasing and lasting natural stone surface.

The retaining elements can be designed for various purposes. One is to use spacers as retaining elements which are inserted into the concrete casting mold in order to carry the at least one natural stone. The cast concrete then covers the spacers. Since with this method, the spacers are cast in concrete, it is proposed to use a steel reinforcement as the spacer.

If, however, the depths of immersion of the natural stones to be used differ too much from each other, or if the stones are to be arranged in a certain way in order to obtain certain designs of the wall, or if the position of the stones is chosen when the stones are finally arranged and can be seen in their future position, the invention proposes to use suspensions for the retaining elements. These are located on top of the concrete casting mold and are attached to the natural stone in expediently 3 spots not immersed in the concrete. Using 3 vertically movable adjusting elements, each stone can be brought into the desired position. The special advantage of this method is that the person arranging the natural stones can see the visible side of the later precast component and is therefore able to carry out certain designs. According to the given future purpose of the precast component, a planar side of a stone can be the visible side or projections and any effects can be created by choosing certain surfaces. This procedure is carried out with adjusting elements that are adjustable in height. Another advantage is that even very large stones can be positioned close to each other making the concrete virtually invisible. For the attachment of one or more suspensions suction cups could be used as they are capable of producing a high holding force on natural stones. For the most simple case pick-up tools of an excavator arm or, for more stones several arms with pick-up tools can be used.

The device according to the invention can be equipped with further elements in every respect according to the method used.

The retaining elements for the at least one natural stone can be spacers, which can be inserted into the concrete casting mold in order to carry the at least one natural stone. For details concerning the method please refer to the details mentioned above. However, it is reasonable to use suspensions as retaining elements which carry the at least one natural stone. The suspensions are attached to the surface of the stone on a spot not immersed in the concrete. These suspensions preferably feature vertically movable adjusting elements in order to be able to bring the at least one natural stone into its position. The stone can be held by various fastening elements. Reasonably suction cups are used which are able to adhere to natural stone surfaces.

In order to achieve a short residence time for the precast component in the concrete casting mold, the invention provides for a method in which, prior to casting the concrete, a stabilization slab is inserted into the concrete casting mold. When the concrete has set, the stabilization slab, which still carries the precast component, is removed.

According to the method, the task is solved by using a concrete casting mold into which a stabilization slab can be inserted. This slab is used to remove and to carry the set but not yet hardened precast component.

Using this method, a concrete casting mold in combination with retaining elements is effectively used for the positioning of natural stones, as the green hardness is sufficient to remove the precast component carried by the stabilization slab. If, furthermore, an appropriate concrete mix is used, comparatively short production cycle times between the individual casting processes can be attained.

Furthermore, the invention relates to precast components produced in the manner described above and especially to precast components which are not easily recognizable as single precast components when several are lined-up. To reach that aim the precast elements must have at least one projecting natural stone, which fits exactly into the negative mold of the adjacent precast component.

A further feature of the method provides the opportunity to remove a set precast component by tilting the concrete casting mold. In so doing, the precast component can be removed more easily from the concrete casting mold and can, for instance, be supported by its later base. For this purpose, a concrete mix with a short setting time is recommended so that sufficient stability can be quickly attained. The removal of the precast component from the concrete casting mold can, as mentioned above, be accelerated by storing the just cast precast component on the stabilization slab. In this case it is possible to insert the stabilization slab non-horizontally into the casting mold for the cast and then to tilt the concrete casting mold to bring the stabilization slab into a horizontal position, such that the precast component is optimally positioned. For instance it is possible to insert the stabilization slab vertically and then tilt the casting mold by 90°.

To stabilize the precast component it is recommended that at least one steel reinforcement or a steel reinforced concrete slab be inserted into the concrete casting mold. A steel reinforced concrete slab inserted in the mold can also serve as a stabilization slab, especially if the steel reinforced concrete slab is used as the base of the precast component to be cast. The steel reinforced concrete slab can also be used as a limit for the concrete casting mold when inserted.

Another possibility is to use a mold closing plate which forms a wall of the concrete casting mold as a stabilization slab. During the hardening process, the precast component is carried by the mold closing plate. The concrete casting mold is then equipped with another mold closing plate so that the next precast component can be cast. In this case, a sufficient number of mold closing plates are required in order to guarantee constant production while one precast component completely hardens.

If a stabilization slab is used, either constructed as a steel reinforced concrete slab or as a mold closing plate, a removable fastening element carrying the stabilization slab can be designed which is used to remove the set precast component.

For stability purposes of the precast component, the depth of immersion of the natural stones into the concrete is of significant importance. The depth of immersion of the at least one natural stone should cover at least 20% of the stone's volume. In order to obtain a very high stability, the depth of immersion of a natural stone should cover at least half of the stone's volume.

If several large stones are to be used on the visible side of the precast component obvious gaps will occur, especially if unhewn natural stones such as boulders or rough quarry stones are to be processed. In order to close the gaps it is recommended to insert smaller natural stones into the concrete. Depending on the size of the natural stones, the retaining elements mentioned further above can also be used in this layout. Furthermore, smaller natural stones can be inserted manually, especially if their weight allows for them to be put on the concrete without them sinking into it. For this purpose, a short waiting period is recommended so that the concrete will become more viscous.

For practical reasons, a concrete mix is recommended which is sufficiently fluid so as to allow easy arrangement of the natural stones in any position, and which, at the same time, hardens quickly in order to fix the stones in their position within a short time.

According to the purpose, the layout of the method can be carried out in a way in which the visible concrete is covered with a weather-resistant protective coating, for instance, made of epoxy resin or an epoxy resin mix. This is to avoid erosion of the exposed concrete in the joints. The advantage is that the natural stone surface will stay clean and the concrete in the joints will not bloom.

In order to erect the precast component on-site without requiring further concrete processing, a base element can be cast which will subsequently be used as the foundation of the wall. Of course, it is also possible to cast a precast component with at least one connecting reinforcement in order to be able to connect the precast component to further concrete at a later point. Such connecting reinforcements may, for instance, be provided in the base element in order to enlarge the foundation. An enlarged foundation is, for instance, required if landslides have to be borne. In this connection, the connecting reinforcement may protrude on top of the concrete. In this way, a foundation element can be cast which projects from beneath the visible side of the precast component. It is also possible to equip the concrete casting mold with a connecting reinforcement which is located partly in the casting mold and partly protrudes from it, so that it can be removed from the concrete casting mold. In doing so, the base element can be extended at its back part, for instance to connect the foundation with the rock using a further concrete cast.

The production of the precast components is not restricted to a concrete surface that is aligned horizontally during the casting process. The casting of a precast component in a concrete casting mold in an inclined position and with an appropriate concrete consistency is also possible. For this purpose, the concrete must be suitable for application on to an inclined surface and for carrying natural stones on that inclined surface.

In order to be able to build a free-standing wall, further natural stones can be inserted into the concrete casting mold prior to the casting. In this way both sides of the precast component are covered with stones. In doing so, the wall can, for instance, serve as a noise protection wall. In this case measures have to be carried out to prevent the concrete from covering the entire stone. For this purpose, an embedding material can be used which prevents the concrete from covering the entire stone. This material has to be removable after the casting process. If, for instance, sand is used, it will drop off when the precast component is removed.

The aesthetic appearance of the precast components mentioned above can be spoiled if a straight and visible concrete joint appears between two precast components, so that it becomes obvious that the wall consists of several precast components. In order to avoid this, a side wall of the casting mold consisting of variable wall elements is used to cast at least one projecting natural stone in an adjacent area of the precast components to be cast.

To cast one or more projecting stones in concrete, variable wall elements constructed as vertically movable slides can be used which are moved upwards until they touch the at least one projecting natural stone. For the purpose of alignment, it is recommended to use a component having the corresponding negative mold of the projecting stone. Such a negative mold can be achieved if the projection of the natural stone reaches into the casting mold, if variable wall elements limit the side wall and if the projection of the natural stone is covered with agents not combining with the concrete. This is essential as the negative mold has to be removable from the projecting natural stone. In this way the components are produced with projecting stones and negative molds fitting precisely into each other. With this procedure, a pleasing and, regarding the visible impression, an uninterrupted surface is created. As the precast components mesh into each other, high stability is attained that, furthermore, prevents the components from pushing against each other, as, for instance, caused by earth movements.

Even if heavy duty transport vehicles are used, the size of a precast component is limited, especially if the transport route leads over or beneath bridges, along mountain roads with hairpin turns, or if tunnels have to be passed. In this case, the precast components can be produced in smaller sizes and be stacked in order to obtain tall walls. Another possibility is to cast precast components that are suitable to be raised or to create recesses in the coping of the wall into which raises can be inserted on-site. Precast components having devices in their base which fit into the recesses, can also be inserted. Furthermore, it is possible to insert other wall elements, for instance further natural stones or topped off by a noise protection wall.

The device according to the invention can be altered or improved in every respect according to the method described. For instance, the concrete casting mold can be designed in such a way so that a stabilization slab can be inserted. The stabilization slab is used to remove and to carry the set but not yet hardened precast component. The stabilization slab can be a steel reinforced concrete slab that becomes part of the precast component when the cast is finished or it can be a mold closing plate of the kind described above.

Preferably, several mold closing plates should be reserved as stabilization slabs for the concrete casting mold. They are used to limit the side walls of the concrete casting mold. The mold closing plates can be removed together with the precast component. They carry the precast components until these have hardened and they are then re-insertable in the concrete casting mold. If the device is intended for use around the clock, a sufficient number of stabilization slabs have to be reserved for a concrete casting mold in order to be able to cast further precast components while others are still hardening.

Another useful feature is that the concrete casting mold is equipped with a tilting device in order to be able to remove the hardened component from the casting mold. The tilting is preferably carried out such that the precast component finally stands on the stabilization slab.

In order to arrange the stabilization slabs on the concrete casting mold it is useful if the mold offers a support to carry the stabilization slab. A steel reinforced concrete slab can be used as stabilization slab that is inserted into the casting mold and becomes part of the precast component when the cast is done. The support can, of course, also be used to carry one of the above mentioned mold closing plates, which also serve as reusable stabilization slabs. For practical reasons, the support can be withdrawn in order to allow the set precast component to be removed.

The concrete casting mold can also feature apertures used to insert connecting reinforcements which are then located partly in the interior of the mold and partly protrude from the concrete casting mold and thus from the precast component. They are used to connect the component in a further cast. This kind of reinforcement typically projects out from the precast component at its back side.

The following designs of the device are used to align precast components in a way not recognizable as aligned and to create a certain meshing of the components: for this purpose the casting mold can feature at least one variable wall element on one side wall of the casting mold in order to be able to cast a projecting natural stone. Precast components with a projecting natural stone as well as the adjacent component with the corresponding negative mold can be cast using these wall elements. For further details please refer to the method described above. Vertically movable slides can be used as variable wall elements, which can be moved upwards until at least one natural stone is touched.

A further aspect of the invention are precast elements produced according to the method described above and according to the different design possibilities offered by this method. Reference to an especially useful precast component has already been made. Another design enables wall raises to be inserted into recesses in the coping of a component on-site. Such recesses are usually cast with specially designed casting molds. For instance, a slide penetrating the mold can be used, which is removable so that the component can be withdrawn. Or the concrete casting mold is designed in a way in which the hardened component can be removed after the opposing mold closing plate has been withdrawn.

In the following, the invention is explained on the basis of drawings that show different layout designs. The figures show:

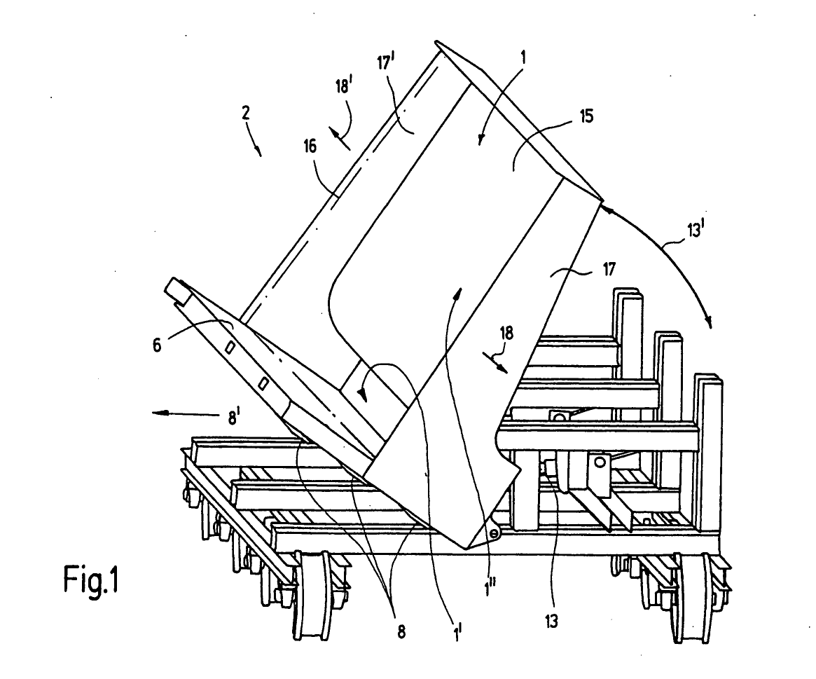

FIG. 1 a possible layout of a concrete casting mold of the device according to the invention,

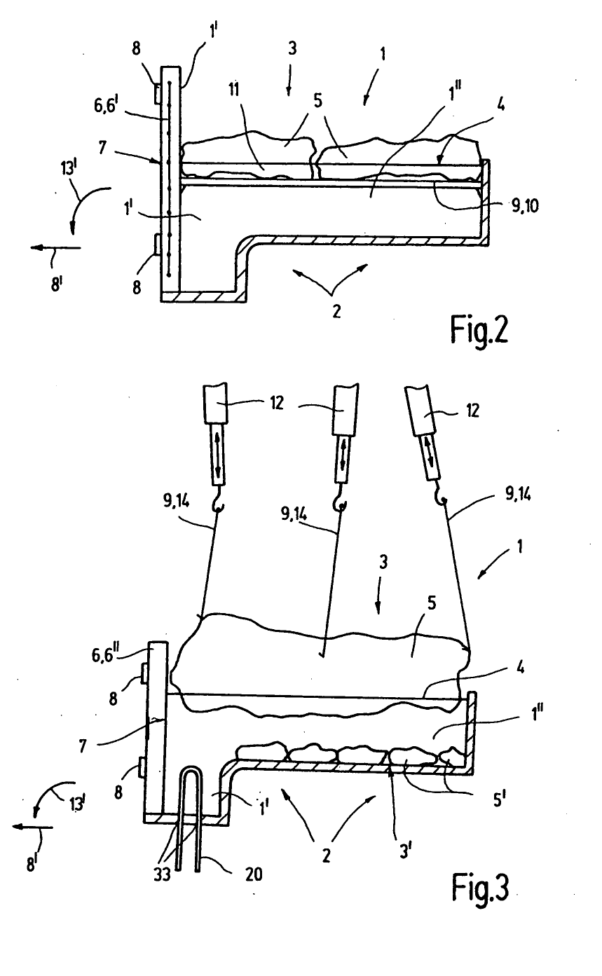

FIG. 2 an example for a device according to the invention featuring retaining elements constructed as spacers,

FIG. 3 an example for a device according to the invention featuring retaining elements constructed as suspensions,

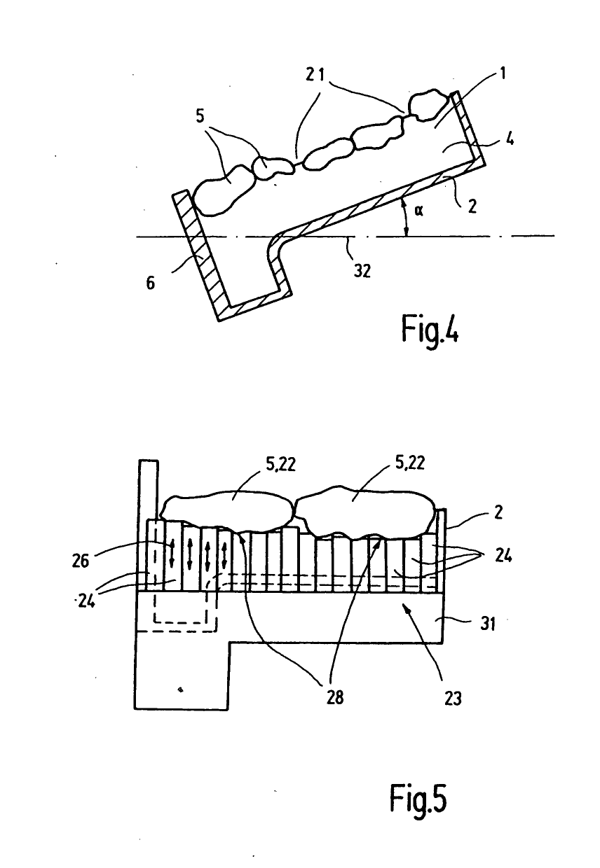

FIG. 4 the production of a precast component with a concrete casting mold in an inclined position,

FIG. 5 the production of a precast component with variable wall elements,

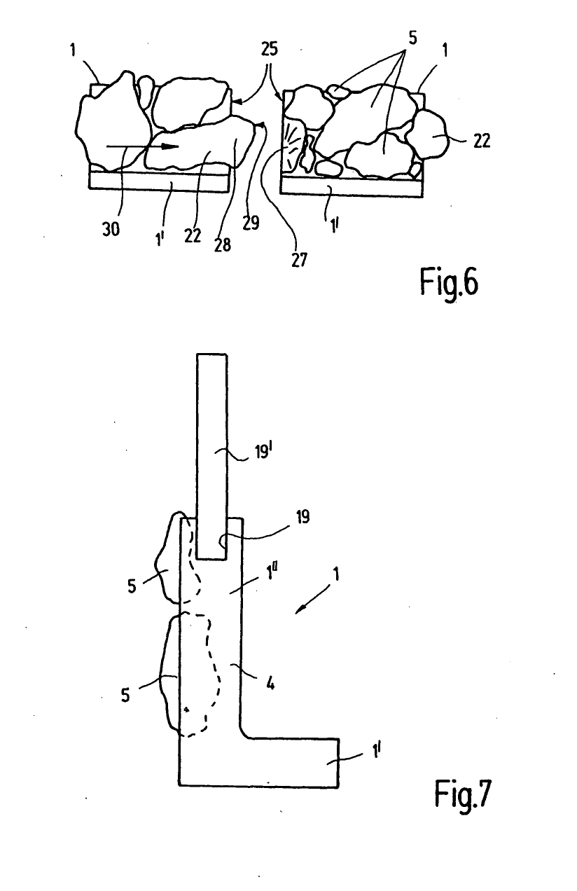

FIG. 6 a connection of precast components with projecting natural stones on the adjacent areas and

FIG. 7 a precast component with an inserted wall raise.

FIG. 1 shows a design of a concrete casting mold 2 of the device according to the invention used to produce precast components 1 that comprise a base element 1′ and a wall element 1″. However, this figure only shows one specific layout of the concrete casting mold 2. For information on the retaining elements 9 for the natural stones 5 and on the precast component 1 being in the concrete casting mold 2 please refer to FIG. 2 to 5. The position of the precast components 1 is, nevertheless, represented by the dash-dotted line 16 in order to show which part of the concrete casting mold 2 is used to form the base element 1′ and which is used to form the wall element 1″ of the precast component 1.

A stabilization slab 6 can be withdrawn from the concrete casting mold 2 shown in order to remove the precast component 1 from the concrete casting mold 2 when the concrete has obtained its green hardness so that the precast component 1 can be removed. In order to cast the precast component 1, the concrete casting mold 2 is tilted in the direction of the arrow 13′. The dash-dotted line that represents the precast component 1 will then be in a horizontal position. The casting of the precast component 1 and the insertion of natural stones 5, which is discussed and shown further below, is carried out in this position. After the cast is done and the green hardness is attained the mold is tilted in the direction of the arrow 13′ using a tilting device 13. When the stabilization slab 6 has reached a horizontal position, the support 8 is used to remove the stabilization slab 6 along with the precast component 1 in the direction of the arrow 8′. The stabilization slab 6 then carries the precast component 1 until it has hardened.

If the stabilization slab 6 can be reused it is inserted into the concrete casting mold 2 again. In this case several stabilization slabs 6 have to be available in order to guarantee continuous production. The stabilization slab 6 can also be a steel reinforced concrete slab 6′ which is integrated in the precast component 1 and forms the base 7 of the component. Details are described in FIGS. 2 and 3.

In order to facilitate the removal of the precast component 1 from the bottom 15 of the concrete casting mold 2, the side walls 17 and 17′ can be designed in a way, which allows removing them in the direction of the arrows 18 and 18′.

FIG. 2 shows an example of a device according to the invention that features retaining elements 9 constructed as spacers 10. They are inserted in the concrete casting mold 2 whereas the insertion (as shown) can be carried out by placing the retaining elements 9 on cantilevers or by using steel reinforcements as spacers 10 which are positioned at the required height. Various positions of the spacers 10 are also possible if the natural stones 5 used have an unequal thickness. In this case, the concrete 4 is cast into the mold and the natural stones 5 are put on the spacers 10 in a way that guarantees a sufficient area of immersion 11 of the stones in the concrete 4.

Furthermore, this design shows how a stabilization slab 6, which is a steel reinforced concrete slab in this case, is inserted into the concrete casting mold 2 and serves as a side wall and forms the later base 7 of the precast component 1. When the precast component 1 has reached its green hardness the concrete casting mold 2 is tilted 13′ as shown in FIG. 1. After the concrete slab 6′ has reached a horizontal position the precast component 1 is removed from the concrete casting mold 2. The support 8 is moved in the direction of the arrow 8′ and, in doing so, removes the steel reinforced concrete slab 6′ along with the precast component 1 in order to enable the concrete to harden completely. Afterwards, the concrete casting mold 2 is equipped with another steel reinforced concrete slab 6′, which is held by a support, so that the next precast component 1 can be cast.

In this layout, the steel reinforced concrete slabs 6′ form the later base 7 of the precast component 1. The spacers 10 remain in the precast component 1 serving as steel reinforcement so as to offer appropriate stabilization.

FIG. 3 shows an example of a device according to the invention with retaining elements 9 constructed as suspensions 14. In this layout, the suspensions are attached to the visible side 3 of the natural stone 5. For this purpose screwed connections or wedges can be used.

Especially suction cups that can find hold on a natural stone surface can be used. Three suspensions are recommended for this case. With the help of adjusting elements 12 (adjustable in height as the double-arrows indicate) the natural stone 5 can be aligned in any way desired.

The natural stone 5 or stones are inserted and arranged after the concrete 4 is cast. The natural stone 5 is maintained in its position by using the adjusting elements 12 until the concrete 4 has attained a degree of strength sufficient to hold the position of the natural stones 5.

When the hardening process of the precast component 1 has come to a point where it can be removed, the concrete casting mold 2 can also be tilted for this purpose in this layout. The precast component 1 is removed along with the stabilization slab 6 (arrows 13′ and 8′). The stabilization slab then carries the precast component until it has completely hardened. For the purpose of holding and removing the stabilization slab 6, supports 8 are used the way described above.

Unlike the design in FIG. 2 the stabilization slab 6 here is a mold closing plate that can be reused after the precast component 1 has hardened. In this case, a storage site where the precast components 1 can harden, is available. Furthermore it is recommended that a sufficient number of mold closing plates 6″ is available in order to enable new precast components 1 to be cast while the others completely harden.

Furthermore, FIG. 3 shows how a connecting reinforcement 20 can be inserted into the concrete casting mold 2 via apertures 33. The connecting reinforcement 20 is used to enable a further cast to be carried out on the base element 1′ of the precast component 1 in order to provide stability for the component. This procedure can be performed on-site.

FIG. 3 shows another possible design. Further natural stones 5′ can be inserted into the concrete casting mold 2 in order to obtain a further visible side 3′ of the precast component 1. Please refer to the descriptions above.

FIG. 4 shows the production of precast components 1 with a concrete casting mold 2 in an inclined position. Here it is also possible to arrange the concrete casting mold 2 with an inclination angle a to the horizontal 32 in order to cast a precast component 1. For this purpose, the concrete must have a consistency suitable for an inclined surface 21 to be cast. The natural stones 5 are then placed on that surface. The further layouts can be carried out the way described above.

FIG. 5 shows the production of precast components 1 with variable wall elements which serve as a side wall 23 or, preferably, as both side walls 23 of the concrete casting mold 2. These variable wall elements can be constructed as vertically movable slides 24 which can be moved in the directions indicated by the arrows 26. In this way, the slides can be moved until they touch a natural stone 5, which is a projecting natural stone 22 protruding from the side wall 23. In this layout the concrete casting mold 2 preferentially features such slides 24 on both side walls 23. The slides 23 are moved by drives placed in a housing 31.

FIG. 6 shows precast components 1 which can be produced with a device according to FIG. 5. Here, the left precast component 1 is produced in a way in which a projection 28 of the natural stone 22 on a side face 25 to be adjacent to another is created. The procedure is carried out using the device described in FIG. 5.

The device described in FIG. 5 was used to produce a precast component 1 shown on the right in FIG. 6. This is done by coating the projecting natural stone 22 of the left precast component 1 with an agent not combining with the concrete 29. This coated stone then protrudes into a concrete casting mold 2 of which the side walls have been limited by the inserted slide 24. When the cast is made, a negative mold 27 of the projecting natural stone 22 is created on the other precast component 1.

This way precast components 1 can be produced which have a projecting natural stone 22 and which fit to a precast component 1 having the corresponding negative mold 27. When the two precast components 1 are pushed against each other in the direction of the arrow 30 a precise mesh will be the result. A clean visible side 3 which cannot be recognized as lined-up will be obtained. Furthermore, the meshing precast components 1 provide a high degree of stability. For this purpose all precast components 1 intended to be lined-up have projections 28 and negative molds 27 at the adjacent side faces.

Furthermore, FIG. 6 shows how larger and smaller natural stones 5 can be arranged on the visible side 3 of the precast component 1 in order to avoid the formation of remarkable areas of visible concrete.

FIG. 7 finally shows a precast component 1 having a recess 19 on the top side of the wall element 1″. This recess can, for instance, be used for the insertion of a wall raise 19′. Such a wall raise 19′ can, for example, be made of one or more plate-like natural stones or a noise protection wall can be set on top of the precast component 1. If negative molds 27 are created instead of recesses 19, unhewn natural stones 5 can also be inserted.

The recess 19 can, of course, also be used to carry a further precast element 1 which has a strip on its base element 1′ fitting into the recess 19. In this way, precast components 1 can be stacked, for instance in order to reinforce a slope. The single layers of precast components 1 can be arranged in a staggered manner so as to increase stability.

The layouts shown are, of course, only to be understood as examples. It is, for instance, also possible to insert the stabilization slab 6 directly into the mold bottom 15 so that the precast component 1 can be removed by lifting it from the mold instead of tilting the mold. Steel reinforced slabs 6′ can be cast in the precast component 1 in any desired spot in order to obtain sufficient stability. Of course, the different layouts described by the figures or which can be obtained in the claims and sub-claims, are also imaginable in any other design combination.

### LIST OF REFERENCE NUMBERS

1 Precast component

1′ Base element

1″ Wall element

2 Concrete casting mold

3 Visible side

3′ Further visible side

4 Concrete

5 Natural stones

5′ Further natural stones for a further visible side

6 Stabilization slab

6′ Steel reinforced concrete slab

6″ Mold closing plate

7 Base

8 Support

8′ Arrow: removal of support

9 Retaining elements

10 Spacers

11 Area of immersion

12 Adjusting elements

13 Tilting device

13′ Arrow: tilting

14 Suspension

15 Mold bottom

16 Dash-dotted line: position of the precast component

17, 17′ Side walls

18, 18′ Arrows: removability of side walls

19 Recesses in the coping of the wall element for a wall raise

19′ Wall raise (natural stones, noise protection wall, . . . )

20 Connecting reinforcement

21 Surface of the concrete

22 Projecting natural stone

23 Side walls of the concrete casting mold consisting of variable wall elements

24 Wall elements constructed as vertically movable slides

25 Adjacent areas or side faces of lined-up precast components

26 Arrow: movement of slide

27 Negative mold of a projecting natural stone in the adjacent precast component

28 Projection of the natural stone

29 Agents not combining with the concrete

30 Arrow: lining-up of two precast components

31 Housing for slide

32 Horizontal

33 Apertures for insertion of connecting reinforcements

α Angle of incline of the concrete casting mold

1-47. (canceled)

48. A method for producing a precast component having a base and a wall element using a concrete casting mold having a shape of the precast component, the method comprising the steps of:
a) filling the concrete casting mold with concrete such that a visible side of the wall element of the precast component faces upward;
b) introducing at least one natural stone into a defined position in the concrete at a depth of immersion sufficient for reliable connection with the concrete;
c) maintaining the defined position of step b) until the concrete has attained a strength sufficient to hold the defined position of the at least one natural stone; and
d) removing the precast component from the concrete casting mold when the concrete has set, wherein steps b) and c) are effected using retaining elements, the retaining elements comprising spacers inserted into the concrete casting mold or at least three suspensions from which the at least one natural stone is hung, wherein the spacers support the at least one natural stone and filled-in concrete covers the spacers or wherein the three suspensions are attached to three locations on a surface of the stone not immersed in the concrete, the alignment of the natural stone into the desired position then being effected by means of three vertically adjustable elements cooperating with the three suspensions.

49. The method of claim 48, wherein at least three suction cups fasten the at least three suspensions to the natural stone.

50. The method of claim 48, wherein at least one pick-up tool fastens the at least three suspensions to the natural stone.

51. The method of claim 48, wherein a stabilization slab is inserted into the concrete casting mold prior to casting, the stabilization slab being removed carrying the precast component when the concrete has set.

52. The method of claim 48, wherein the concrete casting mold is tilted to remove the set, precast component.

53. The method of claim 51, wherein the stabilization slab is in a non-horizontal position when the cast is carried out and the concrete casting mold is tilted to attain a horizontal position of the stabilization slab.

54. The method of claim 48, wherein at least one steel reinforcement or one steel reinforced concrete slab is inserted into the concrete casting mold to provide stability for the precast component.

55. The method of claim 54, wherein the steel reinforced concrete slab is also used as a stabilization slab.

56. The method of claim 55, wherein the steel reinforced concrete slab is used as a base of the precast component and is inserted into the concrete casting mold.

57. The method of claim 54, wherein the steel reinforced concrete slab inserted into the concrete casting mold is used as a limitation of the concrete casting mold.

58. The method of claim 52, wherein a mold closing plate, which serves as one of the walls of the concrete casting mold, is used as a stabilization slab, the precast component being carried by the mold closing plate for the hardening process, the method further comprising the step of equipping the concrete casting mold with another mold closing plate for casting of further precast components.

59. The method of claim 51, wherein a removable support for the stabilization slab is designed to remove the set, precast component.

60. The method of claim 48, wherein a depth of immersion is at least 20% of a volume of the at least one natural stone.

61. The method of claim 48, wherein a depth of immersion is at least half a volume of the at least one natural stone.

62. The method of claim 48, further comprising positioning several natural stones in the concrete and filling gap formations with smaller natural stones.

63. The method of claim 48, wherein a concrete mix is fluid enough to enable easy arrangement of the natural stones in any position, while hardening quickly enough to fix the natural stones in a short time.

64. The method of claim 48, wherein a weather resistant protective coating is applied to visible concrete of a visible side.

65. The method of claim 64, wherein the protective coating is made of epoxy resin or an epoxy resin mix.

66. The method of claim 48, further comprising casting a base element that can later be used as a wall foundation.

67. The method of claim 48, further comprising casting the precast component with at least one connecting reinforcement to connect the precast component to others at a later time.

68. The method of claim 66, wherein the base element has at least one connecting reinforcement to connect together a plurality of precast components.

69. The method of claim 67, wherein the connecting reinforcement protrudes from the cast concrete at a top side thereof.

70. The method of claim 67, wherein the connecting reinforcement is partly in the concrete casting mold and partly juts out so that it can be removed from the concrete casting mold.

71. The method of claim 48, wherein the concrete casting mold assumes an inclined position during casting and a concrete is used having a consistency allowing for an inclined surface to be formed, wherein the natural stones are applied to that inclined surface.

72. The method of claim 48, further comprising inserting further natural stones into the concrete casting mold before the concrete is cast to obtain a further visible side.

73. The method of claim 48, further comprising casting-in at least one protruding natural stone at an adjacent side face of the precast component using a side wall of the concrete casting mold having variable wall elements.

74. The method of claim 73, wherein vertically movable slides are variable wall elements which are moved upwards until they touch the at least one projecting natural stone.

75. The method of claim 73, further comprising joining together precast components by using one with at least one projecting natural stone and one with a negative mold corresponding with the projection of the at least one natural stone.

76. The method of claim 75, wherein the negative mold is produced by the natural stone projecting into the concrete casting mold, by variable wall elements limiting the side wall, and by a projection of the natural stone being covered with agents not combining with the concrete in order to be able to remove the projection of the natural stone when the concrete has set.

77. The method of claim 48, further comprising providing the wall element with recesses in the mold to insert a wall raise when the wall is erected on-site.

78. A device for producing a precast component having a base and a wall element using a concrete casting mold having a shape of the precast component, the device comprising:
means for filling the concrete casting mold with concrete such that a visible side of the wall element of the precast component faces upward;
means for introducing at least one natural stone into a defined position in the concrete at a depth of immersion sufficient for reliable connection with the concrete;
means for maintaining the defined position until the concrete has attained a strength sufficient to hold the defined position of the at least one natural stone; and
means for removing the precast component from the concrete casting mold when the concrete has set, wherein said introducing and said maintaining means comprise retaining elements, the retaining elements comprising spacers inserted into the concrete casting mold or at least three suspensions from which the at least one natural stone is hung, wherein the spacers support the at least one natural stone and filled-in concrete covers the spacers or wherein the three suspensions are attached to three locations on a surface of the stone not immersed in the concrete, the alignment of the natural stone into the desired position then being effected by means of three vertically adjustable elements cooperating with the three suspensions.

79. The device of claim 78, wherein at least one suction cup fastens the at least one suspension on one natural stone.

80. The device of claim 78, wherein at least one pick-up tool fastens the at least one suspension on one natural stone.

81. The device of claim 78, wherein the concrete casting mold is structured and dimensioned to insert a stabilization slab, the stabilization slab carrying and removing a set, but not completely hardened, precast component.

82. The device of claim 78, wherein the concrete casting mold has a tilting device to remove a hardened precast component.

83. The device of claim 81, wherein the concrete casting mold has several mold closing plates serving as stabilization slabs, each used to limit one side of the concrete casting mold, the mold closing plates being removable and carry the precast components until these have hardened, wherein the mold closing plates can be subsequently reinserted into the concrete casting mold.

84. The device of claim 81, wherein the concrete casting mold has a support to carry at least one stabilization slab.

85. The device of claim 81, wherein the stabilization slab is a steel reinforced concrete slab that can be inserted into the concrete casting mold and which becomes part of the precast component during casting.

86. The device of claim 84, further comprising a removable support for withdrawal of a set precast component.

87. The device of claim 78, wherein the concrete casting mold has apertures for insert connecting reinforcements which are then partly inside and partly outside of the concrete casting mold to fascilitate connection of the precast component to another still to be cast.

88. The device of claim 78, wherein the concrete casting mold has at least one side wall that comprises variable wall elements to cast a projecting natural stone.

89. The device of claim 88, wherein vertically movable slides constitute the variable wall elements and can be moved upwards to touch the at least one projecting natural stone.

90. A prefabricated constructional component having a base member and a wall member which is molded using a concrete mold and has visible stones embedded into the concrete at a visible side of the wall portion, wherein a plurality of large, natural stones, which can no longer be handled manually and which are irregular in shape, are rigidly connected to the concrete in such a fashion that a submerged surface of the stone is bound to the concrete during hardening thereof and has a penetration depth which is sufficient to guarantee secure attachment to the concrete, wherein the natural stones have individually different installed positions with regard to a configuration of a surface, a choice of a visible side, and a depth of penetration into the concrete or with regard to a chosen protrusion out of the surface.

91. The precast component of claim 90, wherein the precast component has at least one natural stone with a projection in an adjacent area which corresponds to a negative mold of an adjacent precast component in a manner in which the components are connectible.

92. The precast component of claim 90, wherein recesses are formed in a coping area to allow placement of a wall raise when the wall is erected on-site.
